(19) United States
(12) Patent Application Publication
(10) Pub. No.: US 2026/0339782 A1
(43) Pub. Date: Oct. 29, 2026

(54) METHOD OF EXECUTING ERROR RECOVERY WITH ERROR LIKELIHOOD INFORMATION AND RELATED MEMORY CONTROLLER AND DATA STORAGE DEVICE

(71) Applicant: Silicon Motion, Inc., Hsinchu County (TW)

(72) Inventor: Duen-Yih Teng, Hsinchu County (TW)

(73) Assignee: Silicon Motion, Inc., Hsinchu County (TW)

(21) Appl. No.: 19/186,645

(22) Filed: Apr. 23, 2025

(51) Int. Cl. G06F 11/10

(52) U.S. Cl. CPC G06F 11/1068; G06F 11/1004

(57) ABSTRACT

A method for executing error recovery in a flash memory includes: retrieving a codeword from a data group in the flash memory; performing a first horizontal decoding on the retrieved codeword; in response to a failure of the first horizontal decoding, performing an exclusive-OR (XOR) operation according to the retrieved codeword and XOR-derived parity data in the data group to generate error likelihood information for the retrieved codeword; updating soft information corresponding to the retrieved codeword based on the error likelihood information; and performing a second horizontal decoding on the retrieved codeword based on the updated soft information.

### BACKGROUND OF THE INVENTION

### 1. FIELD OF THE INVENTION

The present invention relates to flash memory, and more particularly to a method of executing error recovery with error likelihood information and related memory controller and data storage device.

### 2. DESCRIPTION OF THE PRIOR ART

In modern memory systems, particularly non-volatile (NV) memory such as NAND flash, data integrity is maintained through the use of error correction codes (ECC). ECC techniques allow for the detection and correction of bit errors that may occur during data storage or retrieval due to device aging, read/write disturbances, or other physical anomalies.

A typical ECC scheme operates by encoding user data into structured codewords containing both payload bits and parity bits. Upon retrieval, a decoder utilizes these parity bits to detect and correct errors based on the encoding scheme. However, all ECC schemes are subject to inherent correction capability limits. When the number of bit errors in a codeword exceeds the correction capability limits, the decoder may fail to correct the codeword, resulting in potential data loss or uncorrectable read errors.

Therefore, there exists a need for an enhanced error recovery mechanism that operates beyond the conventional correction capability of the conventional ECC scheme.

### SUMMARY OF THE INVENTION

The present invention provides an enhanced error recovery method that utilizes a dual-decoder cooperative architecture comprising a horizontal decoder and a vertical decoder. The horizontal decoder performs an ECC decoding on individual codewords retrieved from the flash memory. In contrast, the vertical decoder operates across multiple codewords within a data group, generating XOR-based parity relationships (e.g., RAID-style parity) to enable inter-codeword data reconstruction and error estimation.

When a codeword cannot be corrected by the horizontal decoder alone, the vertical decoder is employed to either reconstruct the codeword or generate error likelihood information based on cross-codeword parity analysis. The error likelihood information is then used to adjust reliability metrics of original soft information of the codeword, enabling a second-pass soft-decision decoding with improved correction potential.

This collaborative approach significantly increases the probability of successful error correction beyond the intrinsic correction capability limit of a single decoder and allows for adaptive multi-pass decoding in memory systems encountering high error rates.

According to one embodiment, a method for executing error recovery in a flash memory is provided. The method comprise: retrieving a codeword from a data group in the flash memory; performing a first horizontal decoding on the retrieved codeword; in response to a failure of the first horizontal decoding, performing an exclusive-OR (XOR) operation according to the retrieved codeword and XOR-derived parity data in the data group to generate error likelihood information for the retrieved codeword; updating soft information corresponding to the retrieved codeword based on the error likelihood information; and performing a second horizontal decoding on the retrieved codeword based on the updated soft information.

According to one embodiment, a memory controller for use in a flash memory is provided. The memory controller comprises: a storage unit, a processing unit and an error correction code (ECC) processing circuit. The storage unit is configured to store program codes. The processing unit is configured to execute the program code to cause the memory controller to retrieve a codeword from a data group in the flash memory. The ECC processing circuit comprises: a horizontal decoder and a vertical decoder. The horizontal decoder is configured to perform a first horizontal decoding on the retrieved codeword. The vertical decoder is configured to perform an exclusive-OR (XOR) operation according to the retrieved codeword and XOR-derived parity data in the data group to generate error likelihood information for the retrieved codeword in response to a failure of the first horizontal decoding. Additionally, the ECC processing circuit is further configured to update soft information corresponding to the retrieved codeword based on the error likelihood information, and the horizontal decoder is further configured to perform a second horizontal decoding on the retrieved codeword based on the updated soft information.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates an electronic device and a data storage device according to one embodiment of the present invention.

FIG. 2 illustrates a data group stored in a NV memory according to one embodiment of the present invention.

FIG. 3 illustrates an error recovery flow based on cooperation of horizontal decoding and vertical decoding according to one embodiment of the present invention.

FIG. 4 illustrates how an information translation module works between a vertical decoder and a horizontal decoder according to one embodiment of the present invention.

FIG. 5 illustrates a flow chart of an error recovery method for use in a flash memory to one embodiment of the present invention.

### DETAILED DESCRIPTION

Embodiments will be described in detail with reference to the accompanying drawings. The inventive concept, however, may be embodied in various different forms, and should not be construed as being limited only to the illustrated embodiments. Rather, these embodiments are provided as examples so that this disclosure will be thorough and complete, and will fully convey the concept of the inventive concept to those skilled in the art. Accordingly, known processes, elements, and techniques are not described with respect to some of the embodiments of the inventive concept. Unless otherwise noted, like reference numerals denote like elements throughout the attached drawings and written description, and thus descriptions will not be repeated. In the drawings, the sizes and relative sizes of layers and regions may be exaggerated for clarity.

Reference throughout this specification to “one embodiment” or “an embodiment” means that a particular feature, structure or characteristic described in connection with the embodiment or example is included in at least one embodiment of the present embodiments. Thus, appearances of the phrases “in one embodiment” or “in an embodiment” in various places throughout this specification are not necessarily all referring to the same embodiment. Furthermore, the particular features, structures or characteristics may be combined in any suitable combinations and/or sub-combinations in one or more embodiments.

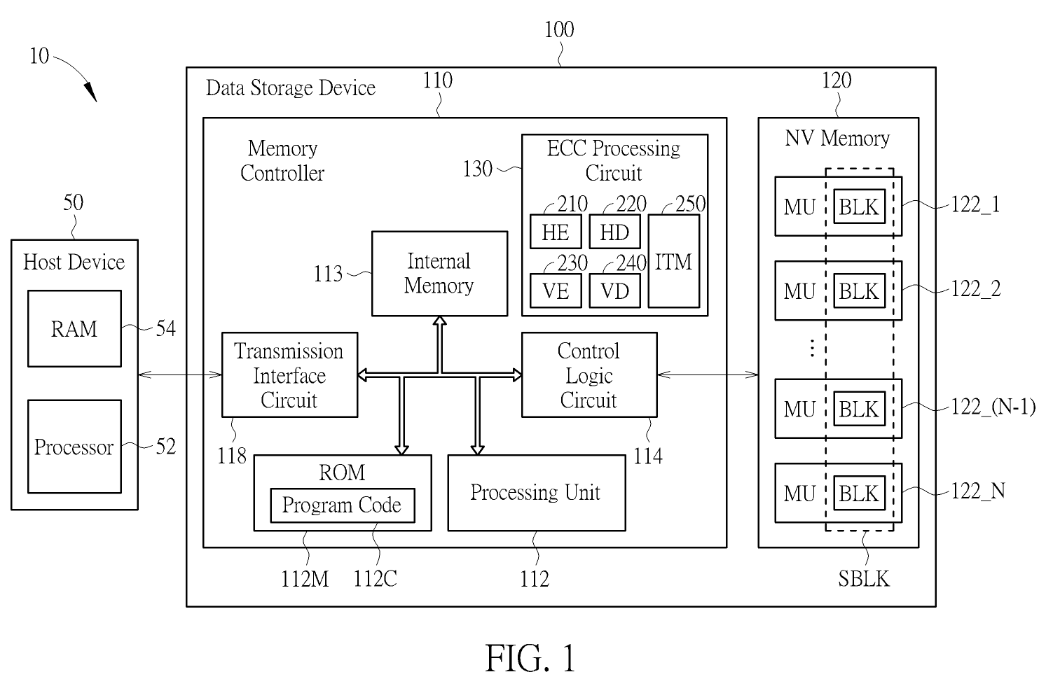

FIG. 1 is a schematic diagram illustrating an electronic device and a data storage device according to one embodiment of the present invention. As illustrated an electronic device 10 comprises a host device 50 and a data storage device 100. The host device 50 may comprise: at least one processor 52 configured to control operations of the host device 50, and a random access memory 54 configured to store data and information required by the processor 52. Examples of the host device 50 may include, but are not limited to: a smartphone, a tablet computer, a wearable device, a personal computer (such as, a desktop computer or a laptop computer), an imaging device (such as, a digital still camera or a video camera), a game console, a car navigation system, a printer, a scanner, or a server system. Examples of the data storage device 100 may include, but are not limited to: a portable memory device (such as a memory card conforming to SD/MMC, CF, MS, XD, or UFS specifications), a solid-state drive (SSD), and various embedded storage devices (such as an embedded storage device conforming to UFS or EMMC specifications).

According to various embodiments, the data storage device 100 may comprise a memory controller 110 and may further comprise a non-volatile (NV) memory 120. The NV memory 120 may comprise one or more NV memory elements, such as a plurality of NV memory elements (MU) 122_1-122_N. For example, the NV memory 120 may be a NAND flash memory, and the NV memory elements 122_1-122_N may be a plurality of NAND flash memory packages or a plurality of NAND flash memory dies, respectively, but the present invention is not limited thereto.

In some embodiments, the NV memory 120 may include a plurality of memory blocks BLK, which may be grouped into a plurality of superblocks SBLK. The memory block BLK may refer to a physical block and includes a plurality of memory cells. The superblock SBLK may be a unit of a logical memory region required for the memory controller 110 to manage the NV memory, where a composition of a superblock SBLK can span across NV memory chips 122_1-122_N. The memory block BLK may be implemented as a memory cell array in which a plurality of memory cells form a two-dimensional (2D) or three-dimensional (3D) array structure. The plurality of memory cells may be single-level cells programmed with one bit or multi-level cells (e.g., double-level cells, triple-level cells or quadruple-level cells) programmed with two bits or more. Moreover, the memory block BLK may include a plurality of pages, where memory cells connected to a same word line may constitute a page. For example, the memory block BLK may be a unit of an erase operation, and the page may be a unit of program and read operations.

In some embodiments, each of NV memory units 122_1-122_N is equipped with control circuitry for executing memory operation commands issued by the memory controller 110. Each of NV memory dies 122_1-122_N may include multiple planes, where each plane may have multiple blocks composed of memory cells, along with associated row and column control circuitry. Through multi-plane operation commands, various memory operations can be applied parallel on different planes to perform multi-plane reading, writing or erasing operations.

The memory controller 110 may comprise a processing unit 112, a read-only memory (ROM) 112M, an internal memory 113, a transmission interface circuit 118, an error checking and correction (ECC) processing circuit 130. At least one portion of these circuits and components may be coupled to one another through a bus. The internal memory 113 can be implemented by one or more RAM devices. For example, the internal memory 113 may comprise a static RAM (SRAM) and/or a dynamic RAM (DRAM). The internal memory 113 could be configured to provide internal storage space for the memory controller 110, for example, temporarily storing information, such as data, addresses, commands, mapping information, and/or variables/parameters. In some embodiments, the memory controller 110 may not include DRAM. Instead, the memory controller 110 may rely on host memory buffer (HMB) technology. With the HMB technology, the memory controller 110 could utilize the RAM 54 (such as DRAM) of the host device 50, as a whole, a part or an extension of the internal memory 113, thereby improving read and write performance of the data storage device 100.

In addition, the ROM 112M in this embodiment is configured to store program code 112C, and the microprocessor 112 is configured to execute the program code 112C, thereby controlling access to the NV memory 120. The program code 112C may include one or more program modules, such as boot loader code. When the data storage device 100 obtains power from the host device 50, the processing unit 112 may execute an initialization process of the data storage device 100 by executing the program code 112C. During the initialization process, the microprocessor 112 may load a set of in-system programming (ISP) codes (not shown in FIG. 1) from the NV memory 120. The microprocessor 112 can execute the ISP codes so that the data storage device 100 can be operable to perform various functions. According to one embodiment of the present invention, the set of ISP codes may include, but are not limited to: one or more program modules associated with memory access (e.g., reading, writing, and erasing), such as, a read operation module, a lookup table module, a wear leveling module, a read refresh module, a read reclaim module, and a garbage collection module , an sudden power-off recovery(SPOR) module, which are provided to perform corresponding reading, lookup table querying, wear leveling, read refreshing, read reclaiming, garbage collection, SPOR and other operations.

The memory controller 110 controls reading, writing, and erasing of the NV memory 120 through a flash control circuit 150. In addition, the memory controller 110 could perform writing of data based on host commands from the host device 50 and writing of valid data which is read from the NV memory 120 by a garbage collection and/or a wear-leveling operation concurrently. The transmission interface circuit 118 may conform to a specific communications specification, such as, Universal Serial Bus (USB) specification, Secure Digital (SD) interface, Ultra High Speed-I (UHS-I) interface, Ultra High Speed-II (UHS-II), CompactFlash (CF) interface, Multimedia card (MMC) interface, embedded Multimedia Card (eMMC) specification, Advanced Technology Attachment (ATA), Serial Advanced Technology Attachment (SATA), Parallel Advanced Technology Attachment (PATA), Peripheral Component Interconnect Express (PCI-E), and Universal Flash Storage (UFS) specification, and may perform communications with the host device 50 according to the specific communications specification.

Typically, the host device 50 may indirectly access the memory device 100, through transmitting host commands and corresponding logic addresses to the memory controller 110. The memory controller 110 receives the host commands and the logic addresses, and translates the host commands to memory operation commands, and further controls the NV memory 120 with the memory operation commands to perform read, program or erase operations upon memory cells or data pages having physical addresses within the NV memory 120.

In some embodiments, a logical-to-physical (L2P) address mapping table having multiple L2P address mapping entries, can be divided into multiple mapping groups. Each mapping group includes a part of entries of the L2P address mapping table and is utilized for performing logical-to-physical address translation. These L2P mapping groups are permanently stored in blocks of NV memory 120 and are loaded into the internal memory 113 when needed. Similarly, a physical-to-logical (P2L) address mapping table having multiple P2L address mapping entries, can be divided into multiple mapping groups. Each mapping group includes a part of entries of the P2L address mapping table and is utilized for performing physical to logical address translation. These P2L mapping groups are permanently stored in blocks of NV memory 120.

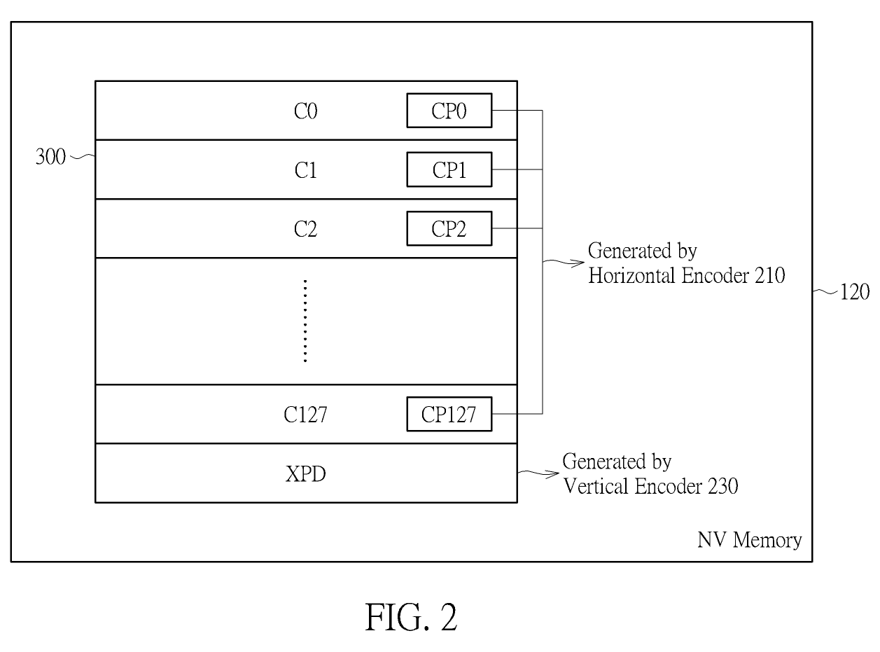

FIG. 2 illustrates a data group included in a NV memory according to one embodiment of the present invention. As illustrated, a data group 300 that is stored in the NV memory 120 may include a plurality of codewords, such as codewords C0-C127. In addition, each of the codewords C0-C127 may be stored at separate pages (or super pages) of the NV memory 200. For example, the codeword C0 may be stored on a first page (or super page) of the NV memory 120 and the codeword C1 may be stored on a second page (or super page) of the NV memory 120. Each of the codewords C0-C127 respectively includes parity bits CP0-CP127, which are used for horizontal error correction. A horizontal decoder (HD) 220 included in or implemented by the ECC processing circuit 130 is configured to validate and decode each of the codewords C0-C127 based on its associated parity bits using a specific error correction algorithm. If one of codewords C0-C127 is determined to be erroneous, the horizontal decoder 220 attempts to correct bit errors using its corresponding parity bits, up to a predefined correction capability limit. In various embodiments, the horizontal decoder 220 may be implemented using a low-density parity-check (LDPC) decoder, a Bose–Chaudhuri–Hocquenghem (BCH) decoder, a Turbo decoder, or a combination thereof, for performing horizontal decoding of the codewords C0-C127.

If one or more of the codewords C0-C127 contain a number of bit errors that exceeds the correction capability limit of the horizontal decoder 220, exclusive-OR (XOR)-derived (i.e., Redundant Array of Independent Disks (RAID)-type) parity data XPD that is included in the data group 300 will be used by a vertical decoder (VD) 240 included in or implemented by the ECC processing circuit 130 to attempt to generate reconstructed versions of the one or more of the codewords C0-C127 containing the number of bit errors exceeding the correction capability limit of the horizontal decoder 220. For example, if the codeword C0 contains the number of bit errors exceeding the correction capability limit of the horizontal decoder 220, the vertical decoder 240 will perform a vertical decoding comprising an XOR operation on the remaining codewords c1-c127 and as the XOR-based parity data XPD to generate reconstructed data of the codeword C0. It should be noted that although FIG. 2 illustrates an example where the data group 300 includes 127 codewords and one set of XOR-derived parity data, the number of codewords and parity data may vary in other embodiments.

Furthermore, the ECC processing circuit 130 is configured to receive data from the host device 50 and generate each of the codewords C0-C127 for storage in the NV memory 120. A horizontal encoder (HE) 210 included in or implemented by the ECC processing circuit 130 is configured to perform a horizontal encoding on user data using a specific ECC encoding scheme. For example, the horizontal encoder 210 could be a low-density parity check (LDPC) encoder, a Bose-Chaudhuri-Hocquenghem (BCH) encoder, a Turbo encoder, or any combination thereof. In addition, a vertical encoder (VE) 230 included in or implemented by the ECC processing circuit 130 is configured to perform a vertical encoding on the data codewords C0-C127 to generate the XOR-derived parity data XPD. For example, the vertical encoder 230 could be a XOR-based (e.g., RAID-type) encoder configured to generate parity data by performing a bit-wise XOR operation across the horizontally encoded codewords C0–C127. Although FIG. 2 illustrates the generation of the XOR-derived parity data XPD based on 127 codewords, in other embodiments, the number of codewords used for generation of the XOR-derived parity data XPD generation may vary depending on system configuration or design requirements.

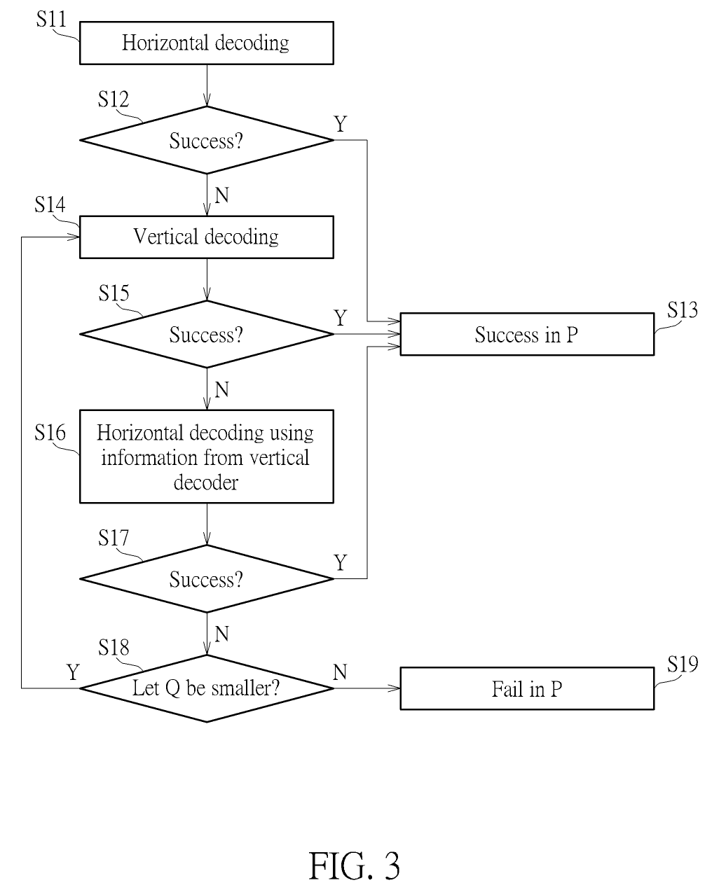

As mentioned above, bit errors occurring in one or more of the codewords C0-C127 read from the NV memory 120 may exceed the correction capacity limit of the horizontal decoder 220. In view of this, the memory controller 110 may retrieve the remaining codewords of the data group 300 from the NV memory 120. The horizontal decoder 220 may attempt decoding of the remaining codewords C0-C127. If a number of incorrect codewords (e.g., codewords that are un-decodable due to excessive errors) is less than or equal to the recovery capability limit of the vertical decoder 240, the vertical decoder 240 would be used to generate reconstructed versions of the one or more incorrect codewords. However, if the number of incorrect codewords exceeds the recovery capability limit of the vertical decoder 240, the vertical decoder 240 is configured to provide bit-level error likelihood information, which may be utilized to enhance soft-decision decoding performed by the horizontal decoder 220 on the incorrect codewords. Please refer to FIG. 3 for further understandings.

FIG. 3 illustrates an error recovery flow based on cooperation of horizontal decoding and vertical decoding according to one embodiment of the present invention. At step S11, the ECC processing circuit 130 employs the horizontal decoder 220 to execute a first horizontal (e.g. LDPC) decoding on a target codeword P (e.g., codeword C0) retrieved from a page of the NV memory 120. At step S12, the ECC processing circuit 130 evaluates whether the horizontal decoding of the codeword P has been successful.

A successful decoding outcome may be determined if the syndrome check performed via multiplication of a parity-check matrix and the retrieved target codeword P yields a zero vector, indicating no detectable errors. Alternatively, the horizontal decoding is also deemed successful if the horizontal decoder 220 is able to converge to a valid codeword by correcting the detected bit errors within its correction capability limit.

In one embodiment, the horizontal decoder 220 performs a soft-decision decoding based on log-likelihood ratio (LLR) inputs. During the horizontal decoding, the horizontal decoder 220 performs iterative message passing between variable nodes and check nodes in the code (e.g., LDPC) structure. At each iteration, extrinsic information is exchanged to refine the bit-level reliability estimates, progressively improving the likelihood of converging to a valid codeword.

In one embodiment, each bit in the retrieved codeword P is associated with soft information represented by an LLR value. The LLR value comprises two components: one sign bit and one or more reliability bits. The sign bit indicates the most likely hard-decision value of the bit, where a sign bit of “0” may indicate a higher likelihood of the bit being logical “0”, and a sign bit of “1” may indicate a higher likelihood of the bit being “1”. The one or more reliability bits indicate a confidence level in the sign decision, for example by representing the magnitude of the LLR value. Higher reliability values indicate greater confidence, while lower values suggest increased uncertainty. The horizontal decoder 220 utilizes the soft information during the iterative decoding process, applying higher weighting to more reliable bits and adjusting correction strategies for bits with lower confidence metrics.

If the horizontal decoding is determined to be successful at step S12, the flow advances to step S13. At this stage, the memory controller 110 transmits the result of the horizontal decoding to the host device 50. The transmitted data may be either from the original, unmodified retrieved target codeword P (if no errors were detected) or from a corrected version of the retrieved target codeword P, if bit errors were successfully corrected by the horizontal decoder 220.

Conversely, if the horizontal decoding is determined to have failed at step S12, the flow proceeds to step S14, where vertical decoding is initiated. In one embodiment, a failure of the horizontal decoding is determined when the horizontal decoder 220 is unable to converge to a valid codeword that satisfies syndrome check within a predefined maximum number of decoding iterations.

At step S14, the ECC processing circuit 130 uses the vertical decoder 240 to perform the vertical decoding. Specifically, all other codewords (e.g., codeword C1-C127) in the same data group of the target codeword P will be retrieved from the NV memory 120. Accordingly, the vertical decoder 240 would perform a bit-wise XOR operation on the XOR-derived parity data (e.g. XPD) and all other retrieved codewords (e.g., codeword C1-C127), thereby to generate a reconstructed version of the retrieved target codeword P based on inter-codeword parity relationships across the data group.

A successful vertical decoding outcome is determined when the reconstructed version of the retrieved target codeword P can either directly satisfy syndrome check performed by the horizontal decoder 220 or when it contains errors that fall within the correction capability limit of the horizontal decoder 220. In the latter scenario, the reconstructed version of the retrieved target codeword P may still contain residual bit errors, but these bit errors are correctable for the horizontal decoder 220. In view of above, the flow proceeds to step S13, where data (e.g. payload data of the codeword) from the reconstructed version of the retrieved target codeword P or the corrected version of the retrieved target codeword P will be transmitted to the host device 50. Conversely, the vertical decoding outcome is deemed unsuccessful when the reconstructed version of the retrieved target codeword P cannot be validated or corrected by the horizontal decoder 220. In this case, the flow transitions to step S16.

At step S16, the ECC processing circuit 130 uses the vertical decoder 240 to generate error likelihood information (ELI) for the retrieved target codeword P. The error likelihood information may represent a bit-level estimation of the likelihood that each bit in the retrieved target codeword P is erroneous. The error likelihood information can be used to adjust the originally retrieved reliability metrics in the soft information for each bit of the retrieved target codeword P. A new LLR value is computed for each bit based on the adjusted reliability, thereby enabling a second horizontal decoding attempt to be performed using the updated soft information.

In one embodiment, the error likelihood information is obtained by performing a bit-wise XOR operation on the retrieved target codeword P (e.g., codeword C0), and all other codewords (e.g., codewords C1-C127) in same data group and the XOR-derived parity data (e.g. XPD). In one embodiment, the error likelihood information may comprise a bit sequence, wherein each bit in the bit sequence indicates an error likelihood value of a corresponding bit position of the retrieved target codeword P. In some embodiment, if one bit position in the bit sequence of the error likelihood information is logical “1”, it means a high likelihood that a corresponding bit position in the retrieved target codeword P is erroneous. In some embodiment, if a bit position in the bit sequence of the error likelihood information is logical “0”, it means a high likelihood that a corresponding bit position in the retrieved target codeword P is correct. It should be noted that the error likelihood information provides a probabilistic estimate rather than a definitive error detection result.

Based on the generated error likelihood information, the ECC processing 130 updates soft information of the retrieved target codeword P. In one embodiment, the soft information for each bit retrieved from the NV memory 120 includes a sign bit and one or more reliability bits, and the ECC processing 130 modifies the one or more reliability bits for each bit of the retrieved target codeword P based on the generated error likelihood information.

In one embodiment, in order to generate the updated soft information for the horizontal decoder 220, the ECC processing 130 would update “original” soft information of the retrieved target codeword P that is determined at the target codeword P is retrieved from the NV memory 120 rather than “intermediate” soft information values that may have been modified during previous iterative decoding steps (e.g., steps S11–S15). Accordingly, the horizontal decoder 220 would use the updated soft information (e.g., the combination of the original soft information and the error likelihood information) of the retrieved target codeword P to perform a second horizontal decoding attempt. At step S17, it is determined whether the second horizontal decoding is successful. If the second horizontal decoding is successful, the flow proceeds to step S13 to return data (e.g. payload data of the codeword) from the corrected version of the retrieved target codeword P to the host device 500; otherwise the flow transition to step S18.

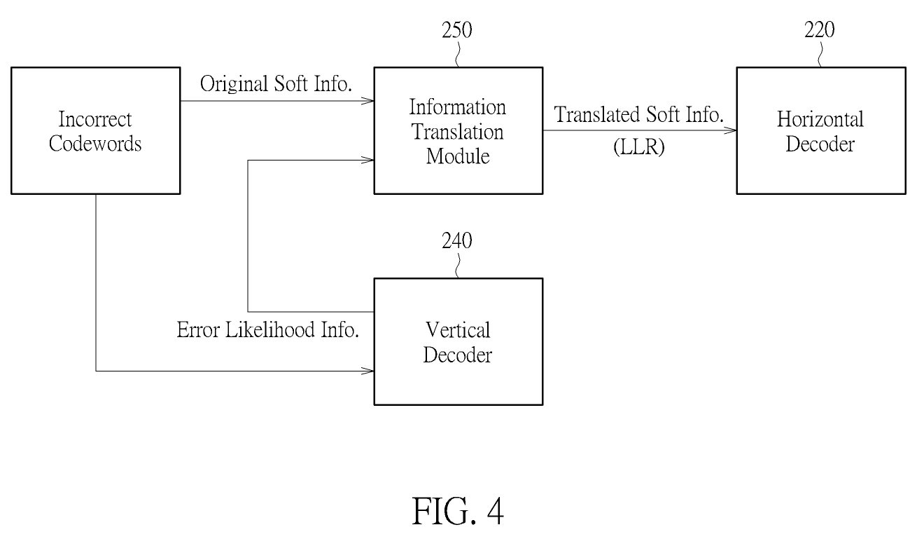

In one embodiment, the ECC processing 130 further comprises an information translation module (ITM) 250. Please refer to FIG. 4 for further understanding. As illustrated, the information translation module 250 is configured to combine (e.g., translate) the original soft information for each bit of the retrieved target codeword P and the error likelihood information for each bit of the retrieved target codeword P (that is generated by the vertical decoder 240) to generate a translated soft information for each bit of the retrieved target codeword P. The translated soft information for each bit of the retrieved target codeword P is compatible with the bit-width requirement (e.g., limit) of the horizontal decoder 220. For example, if the soft information for each bit in the retrieved target codeword P includes 1 sign bit and 2 reliability bits, and the error likelihood information for each bit of the retrieved target codeword P is one bit, the information translation module 250 would map the 2-bit reliability information and 1-bit error likelihood information into a translated 2-bit reliability information, such that the total soft information (1 sign bit + 2 translated reliability bits) remains compatible with the input format of the horizontal decoder 220.

At step S18, it is determined that whether a total number “Q” of incorrect retrieved codewords (including the retrieved target codeword P) in the data group has decreased as a result of the decoding process performed in steps S11 through S16.

In some cases, some of the other codewords (e.g., codeword C1-C127) may be identified as incorrect after being retrieved from the NV memory 120 during the vertical decoding at step S14. Even if bit errors within the retrieved target codeword P remain uncorrected after step S16, it is possible that bit errors in other incorrect retrieved codewords can be corrected, thereby improving the overall data group reliability. This means it is still possible to successfully correct the retrieved target codeword P after several iterations of step S11-S16 later. Hence, if the total number “Q” of incorrect codewords has been reduced after step S16, the flow returns to step S11 to repeat the error recovery flow, utilizing newly corrected codewords to assist in the reconstruction or decoding of the remaining codewords, including the retrieved target codeword P. However, if no progress is detected (i.e., the number of incorrect codewords remains the same), the flow terminates at step S19, where the decoding of the retrieved target codeword is declared as failed.

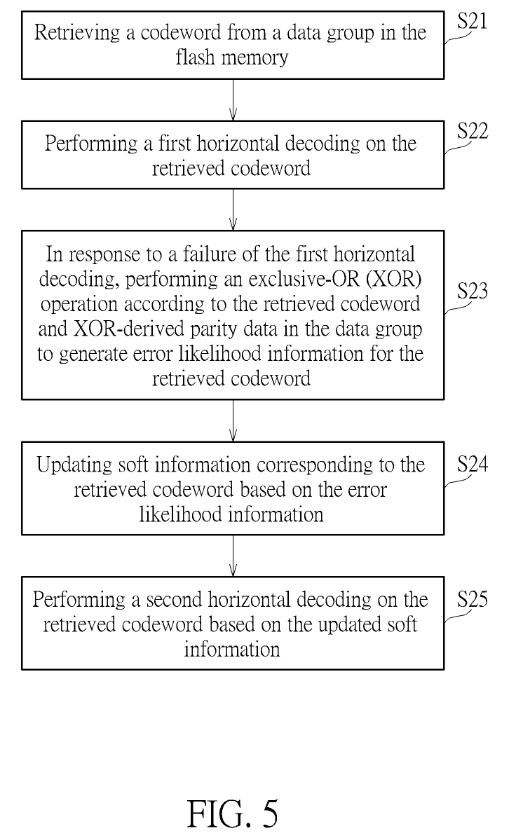

FIG. 5 illustrates a flow chart of for executing error recovery in a flash memory to one embodiment of the present invention. As shown in the figure, the error recovery method includes the following steps:
S21: retrieving a codeword from a data group in the flash memory;
S22: performing a first horizontal decoding on the retrieved codeword;
S23: in response to a failure of the first horizontal decoding, performing an exclusive-OR (XOR) operation according to the retrieved codeword and XOR-derived parity data in the data group to generate error likelihood information for the retrieved codeword;
S24: updating soft information corresponding to the retrieved codeword based on the error likelihood information; and
S25: performing a second horizontal decoding on the retrieved codeword based on the updated soft information.

Since the principle and specific details of the foregoing steps have been described expressly in the above embodiments, further descriptions will not be repeated here. It should be noted that the above flow may achieve better the read performance of the flash memory and error recovery efficiency by adding other extra steps or making appropriate modifications and/or adjustments.

Embodiments in accordance with the present embodiments can be implemented as an apparatus, method, or computer program product. Accordingly, the present embodiments may take the form of an entirely hardware embodiment, an entirely software embodiment, or an embodiment combining software and hardware aspects that can all generally be referred to herein as a “module” or “system.” Furthermore, the present embodiments may take the form of a computer program product embodied in any tangible medium of expression having computer-usable program code embodied in the medium. In terms of hardware, the present invention can be accomplished by applying any of the following technologies or related combinations: an individual operation logic with logic gates capable of performing logic functions according to data signals, and an application specific integrated circuit (ASIC), a programmable gate array (PGA) or a field programmable gate array (FPGA) with a suitable combinational logic.

The flowchart and block diagrams in the flow diagrams illustrate the architecture, functionality, and operation of possible implementations of systems, methods, and computer program products according to various embodiments of the present embodiments. In this regard, each block in the flowchart or block diagrams may represent a module, segment, or portion of code, which comprises one or more executable instructions for implementing the specified logical function(s). It is also noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions. These computer program instructions can be stored in a computer-readable medium that directs a computer or other programmable data processing apparatus to function in a particular manner, such that the instructions stored in the computer-readable medium produce an article of manufacture including instruction means which implement the function/act specified in the flowchart and/or block diagram block or blocks.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for executing error recovery in a flash memory, comprising:
retrieving a codeword from a data group in the flash memory;
performing a first horizontal decoding on the retrieved codeword;
in response to a failure of the first horizontal decoding, performing an exclusive-OR (XOR) operation according to the retrieved codeword and XOR-derived parity data in the data group to generate error likelihood information for the retrieved codeword;
updating soft information corresponding to the retrieved codeword based on the error likelihood information; and
performing a second horizontal decoding on the retrieved codeword based on the updated soft information.

2. The method of claim 1, wherein the data group comprises a plurality of other codewords, the retrieved codeword and the XOR-derived parity data.

3. The method of claim 2, wherein the plurality of other codewords and the retrieved codeword are generated by a horizontal encoding, wherein the horizontal encoding is low-density parity-check (LPDC) encoding.

4. The method of claim 2, wherein the XOR-derived parity data is generated by performing a vertical encoding comprising an XOR operation on all of the plurality of codewords in the data group.

5. The method of claim 2, further comprising:
in response to the failure of the first horizontal decoding, performing a vertical decoding on the XOR-derived parity data and the plurality of other codewords to generate a reconstructed version of the retrieved codeword.

6. The method of claim 5, wherein the vertical decoding comprises an XOR operation on the XOR-derived parity data and the plurality of other codewords.

7. The method of claim 5, wherein the step of generating the error likelihood information comprises:
in response to the failure of the vertical decoding, performing the XOR operation on the retrieved codeword, the plurality of other codewords and the XOR-derived parity data to generate the error likelihood information.

8. The method of claim 1, wherein the first and second horizontal decoding are LPDC decoding and the second horizontal decoding is based on a soft-decision manner.

9. The method of claim 1, wherein the soft information comprises a sign bit and one or more reliability bits for each bit of the retrieved codeword, and the step of updating the soft information comprises:
updating the one or more reliability bits for each bit of the retrieved codeword according to the error likelihood information in a bit-wise manner.

10. The method of claim 9, further comprising:
translating the error likelihood information for each bit of the retrieved codeword and the one or more reliability bits for each bit of the retrieved codeword into translated reliability information that conforms to a bit-width requirement of the second horizontal decoding.

11. A memory controller for use in a flash memory, comprising:
a storage unit configured to store program codes;
a processing unit configured to execute the program code to cause the memory controller to retrieve a codeword from a data group in the flash memory; and
an error correction code (ECC) processing circuit, comprising:
a horizontal decoder, configured to perform a first horizontal decoding on the retrieved codeword; and
a vertical decoder, configured to perform an exclusive-OR (XOR) operation according to the retrieved codeword and XOR-derived parity data in the data group to generate error likelihood information for the retrieved codeword in response to a failure of the first horizontal decoding;
where the ECC processing circuit is further configured to update soft information corresponding to the retrieved codeword based on the error likelihood information; and the horizontal decoder is further configured to perform a second horizontal decoding on the retrieved codeword based on the updated soft information.

12. The memory controller of claim 11, wherein the data group comprises a plurality of other codewords, the retrieved codeword and the XOR-derived parity data.

13. The memory controller of claim 12, wherein the ECC processing circuit further comprises a horizontal encoder that is configured to perform a horizontal encoding to generate the plurality of other codewords and the retrieved codeword, wherein the horizontal encoding is low-density parity-check (LPDC) encoding and the horizontal encoder is an LDPC encoder.

14. The memory controller of claim 12, wherein the ECC processing circuit further comprises a vertical encoder that is configured to perform an XOR operation on all of the plurality of codewords in the data group, thereby to generate the XOR-derived parity data.

15. The memory controller of claim 11, wherein the vertical decoder is further configured to perform a vertical decoding on the XOR-derived parity data and the plurality of other codewords to generate a reconstructed version of the retrieved codeword in response to the failure of the first horizontal decoding.

16. The memory controller of claim 15, wherein the vertical decoder is configured to perform the vertical decoding comprising an XOR operation on the XOR-derived parity data and the plurality of other codewords.

17. The memory controller of claim 15, wherein the vertical decoder is configured to perform the XOR operation on the retrieved codeword, the plurality of other codewords and the XOR-derived parity data to generate the error likelihood information in response to the failure of the vertical decoding.

18. The memory controller of claim 11, wherein the first and second horizontal decoding are low-density parity-check (LPDC) decoding, the second horizontal decoding is based on a soft-decision manner and the horizontal decoder is an LDPC decoder.

19. The memory controller of claim 11, wherein the soft information comprises a sign bit and one or more reliability bits for each bit of the retrieved codeword, and the ECC processing circuit is configured to update the one or more reliability bits for each bit of the retrieved codeword according to the error likelihood information in a bit-wise manner.

20. The memory controller of claim 19, wherein the ECC processing circuit further comprises:
an information translation module, configured to translate the error likelihood information for each bit of the retrieved codeword and the one or more reliability bits for each bit of the retrieved codeword into translated reliability information that conforms to a bit-width requirement of the second horizontal decoding.

21. A data storage device comprising a flash memory and the memory controller of claim 11.
